(19) United States
(12) Patent Application Publication
(10) Pub. No.: US 2006/0177031 A1
(43) Pub. Date: Aug. 10, 2006

(54) Vault guard for providing security and preventing vandalism

(76) Inventors: David Grudzinski, Houston, TX (US); William W. White, Houston, TX (US)

Correspondence Address: KEELING PATENTS AND TRADEMARKS, 3310 KATY FREEWAY, SUITE 100, HOUSTON, TX, 77007, US

(21) Appl. No.: 11/040,356

(22) Filed: Jan. 21, 2005

(51) Int. Cl. H04M 17/00

(52) U.S. Cl. 379/143

(57) ABSTRACT

The invention is a guard for preventing the vandalism of the vault and vault door of a pay telephone. The inventive guard includes a plurality of attachment points and an extended perimeter member. The attachment points have a shoulder raised above the exterior surface of the inventive guard. When a fastener is inserted through the attachment point, the head of the fastener will be flush or inset with respect to the top surface of the shoulder, thereby preventing leveraging against the fastener head. Additionally, a de minimus gap formed between the perimeter of the fastener head and the inner wall of the shoulder prevents insertion of a prying instrument. A perimeter member circumscribes the access opening for the vault door. The perimeter member outwardly extends, changing the leverage point of a prying instrument such that a vandal is prevented from obtaining the leverage necessary to forcibly remove the vault door.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of the Invention

The present invention relates generally to a guard to prevent the destruction and vandalism of a pay telephone vault door. Specifically, the invention is a vault guard that prevents a potential vandal from gaining the leverage necessary to pry open the telephone vault door.

Pay telephones are typically installed in isolated, unprotected locations. Over a prolonged period of time, an amount of coin money is retained within the vault of a pay telephone. Consequently, pay telephones are the subject of frequent vandalism attempts.

Vandals often attempt to access the coin money within the telephone vault by forcibly prying the vault door from the lower housing of the pay telephone. To do so, vandals insert a pry bar into the space between the vault door and the lower housing and exert torsion about the edge of the lower housing and approaching normal with respect to the vault door. The torsion applied by the pry bar shears or bends the locking mechanism of the vault door, thereby removing the vault door and leaving the vault open for the vandal. The present invention is directed to preventing vandalism to the telephone vault door, thereby preventing access to money in the pay telephone coin vault.

Alternatively, vandals may attempt to access the pay telephone vault by drilling through the pay telephone lower housing. The present invention increases security to the pay telephone vault by providing armor protection to the pay telephone lower housing.

2. Description of the Related Art

Several inventions to prevent vandalism and destruction of pay telephone vaults are known to the art. The prior art is difficult to install on pre-existing pay telephones. Some armors require a plurality of inner fitting parts, while others require that the pay telephone first be at least partly disassembled for installation. Additionally, some armors are installed by welding, which is difficult to perform on a pre-existing pay telephone. Illustrative of such inventions are U.S. Pat. No. 5,402,476 issued to Ohayon, U.S. Pat. No. 5,818,932 issued to Zausner, and U.S. Pat. No. 6,549,618 issued to Grudzinski.

The Ohayon '476 patent teaches a two-part armor, one part for the upper housing and one part for the lower housing. The lower housing armor includes an opening for the vault door and an opening for the coin return box. The lower housing armor also includes a removable plate that is attached to the vault door. The lower armor is welded to the lower housing of the pay telephone, which is difficult to perform on a pay telephone preexisting on site.

The Zausner '932 patent teaches a lower housing that encloses the coin box of a pay phone. The lower housing includes a face plate over the front of the coin box and two side pieces that wrap around the sides of the coin box. The lower housing interlocks with an upper housing, and the lower housing is permanently attached through welding.

The Grudzinski '618 patent teaches a pay telephone lower housing armor, which is fixedly attached to the pay telephone lower housing through welding. The lower housing armor provides an opening for access to the vault door. Additionally, the armor incorporates a plurality of rigid segments, preventing a vandal from exerting a prying force against the vault door.

U.S. Pat. No. 5,134,654 issued to McGough on Jul. 28, 1992 discloses an upper housing shield for a payphone comprising a thick metal plate formed to a “U” shape to wrap around existing payphones. Holes are formed into the housing for the lock, handset cord, coin slot, coin instruction plate, coin release mechanism, etc. The housing shield replaces the standard faceplate on a pay telephone and is attached to the payphone by welding. Thus, McGough requires retrofitting existing pay telephones by completely removing the preexisting upper housing and welding the new housing shield to the preexisting lower housing. This process is exceedingly difficult to complete in the field.

It would thus be beneficial to provide a pay telephone vault guard that deters a vandal from accessing the pay telephone coin vault door by prying or drilling. It would further be beneficial to provide a pay telephone vault guard that is relatively inexpensive, simple to manufacture, and provides a secure exterior appearance. Moreover, it would be beneficial that the vault guard be installed quickly and easily.

### BRIEF SUMMARY OF THE INVENTION

Accordingly, it is an object of the present invention to provide a new and improved telephone vault guard that:
Prevents a vandal from prying out the vault door from the lower housing of a pay telephone;
Protects the lower housing from drilling or other vandalism;
Is relatively inexpensive and simple to manufacture;
Requires little retrofitting to the pay telephone; and
Can be installed easily and quickly.

To achieve such improvements, the present invention is a guard that provides protective armor for the pay telephone coin vault while still allowing access to the pay telephone coin vault. The objectives are accomplished by the structure and method of installation of the inventive vault guard. A critical feature of the vault guard is its thickness, which reinforces the strength of the lower housing. Another critical feature of the vault guard is the construction of the vault guard which surrounds the non-mounting sides of the pay telephone and which, by virtue of raised shoulders surrounding the attachment points, prevents the application of a torsion about the attachment means. A further critical feature of the vault guard is the extended perimeter member, which permits access to the vault by use of a key while preventing entry to the vault by deviant means, such as prying. A further critical feature of the invention is the use of impact rivets, or equivalent single-use attachment means, which may be applied entirely externally, thereby avoiding the need to disassemble, even partly, the pay telephone. As a result of such attachment means, speedy, on-site retrofitting is possible without disassembly.

Other objects of the invention will become apparent from time to time throughout the specification hereinafter disclosed.

### BRIEF DESCRIPTION OF THE DRAWINGS

FIG. 1 is an exploded view of the preferred embodiment of the present invention and a pay telephone.

FIG. 2 is a perspective view of the preferred embodiment of the invention.

FIG. 3 is an isometric view of the second side plate.

### DESCRIPTION OF THE INVENTION

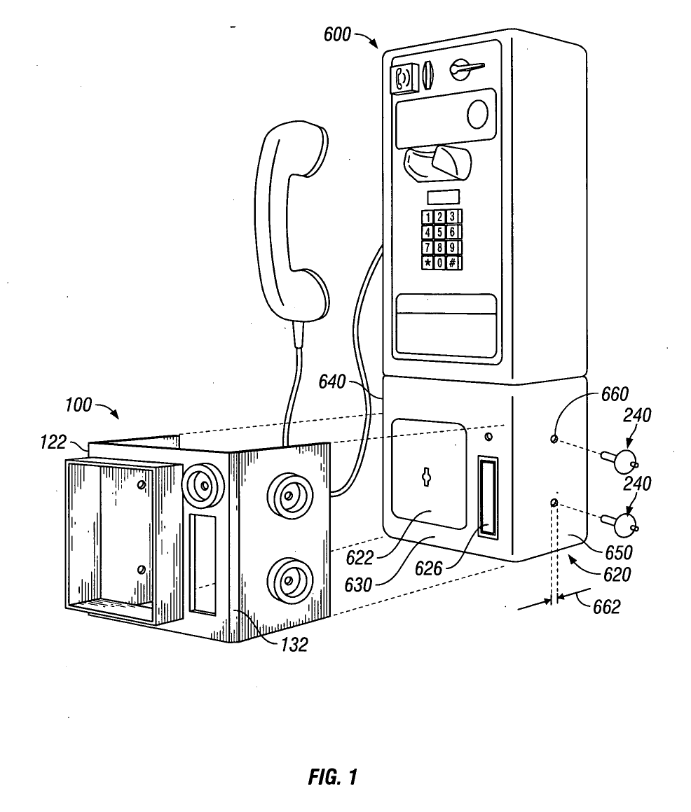

The vault guard is shown generally in FIGS. 1-3 as vault guard 100.

FIG. 1 illustrates vault guard 100 attached to pay telephone 600. The attachment portion of vault guard 100 is generally C-shaped and has internal dimensions nearly identical, absent tolerances, as the exterior surface of pay telephone lower housing 620, such that vault guard 100 is superposed about pay telephone lower housing 620. Vault guard 100 is preferably high strength metal, with sufficient strength and thickness to protect against drilling and heavy striking blows from vandals.

Vault guard 100 includes a plurality of openings 605, which permit access to common functional components of pay telephone 600. Common functional components typically include coin return 626 and vault door 622, seen in FIG. 1. However, additional openings 605 may be provided as needed.

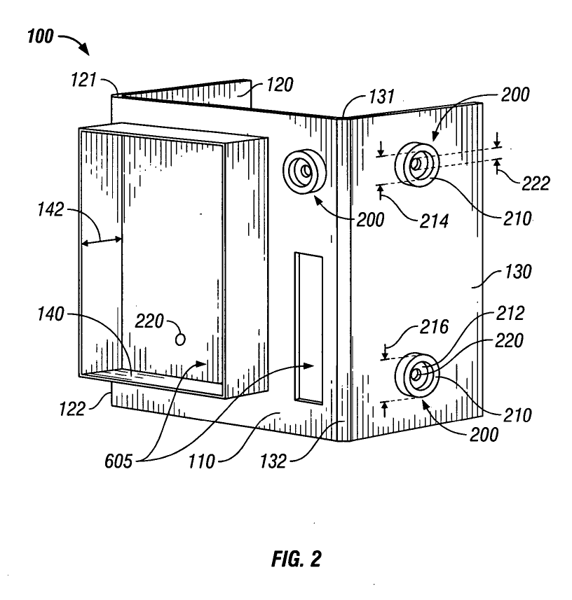

Vault guard 100 is shown separately in FIG. 2. Vault guard 100 is formed by face plate 110, perimeter wall 140, first side plate 120, and second side plate 130. Face plate 110, first side plate 120 and second side plate 130 are of uniform thickness. First side plate 120 is joined rearwardly perpendicular to face plate 110 at junction 121, forming longitudinal edge 122. Second side plate 130 is likewise joined rearwardly perpendicular to face plate 110 at junction 131, forming longitudinal edge 132. Junctions 121 and 131 may be formed by welding or by bending of a single metal plate. Longitudinal edges 122 and 132 may be beveled with respect to first side plate 120 and face plate 110 and with respect to second side plate 130 and face plate 110, respectively. Beveling of longitudinal edges 122 and 132 permits vault guard 100 to contour to the exterior of pay telephone lower housing 620, reducing potential space between vault guard 100 and pay telephone lower housing 620, which might be used as a point of leverage. Alternatively junctions 121 and 131 may be radiused to reduce potential space.

Perimeter wall 140 circumscribes vault door 622 and is typically rectangular in shape. However, perimeter wall 140 may be of any shape, so long as perimeter wall 140 substantially frames vault door 622. Perimeter wall 140 defines an opening 605 and outwardly extends a perimeter wall distance 142 from face plate 110. With perimeter wall 140 around vault door 622, a force in a direction substantially normal to vault door 622 will be required for forceful removal of vault door 622. Extending perimeter wall 140 a perimeter wall distance 142 prevents a vandal from being able to exert a prying moment to enhance a normal force to vault door 622. In the preferred embodiment of the invention, perimeter wall distance 142 is at least 2.54 centimeters (1 inch).

Vault guard 100 provides protection for the vault (not shown) through the mating of vault guard 100 to pay telephone lower housing 620. As seen in FIG. 1, pay telephone lower housing 620 includes face member 630, vault door 622, first side wall 640, and second side wall 650. Vault guard 100 is properly aligned with and superposed about lower housing 620.

Vault guard 100 is secured to lower housing 620 through a plurality of attachment receivers 200. Referring to FIG. 2, in an exemplary embodiment, two attachment receivers 200 are located on first side plate 120. Similarly, two attachment receivers 200 are located on second side plate 130. Additionally, an attachment receiver 200 is located on face plate 110.

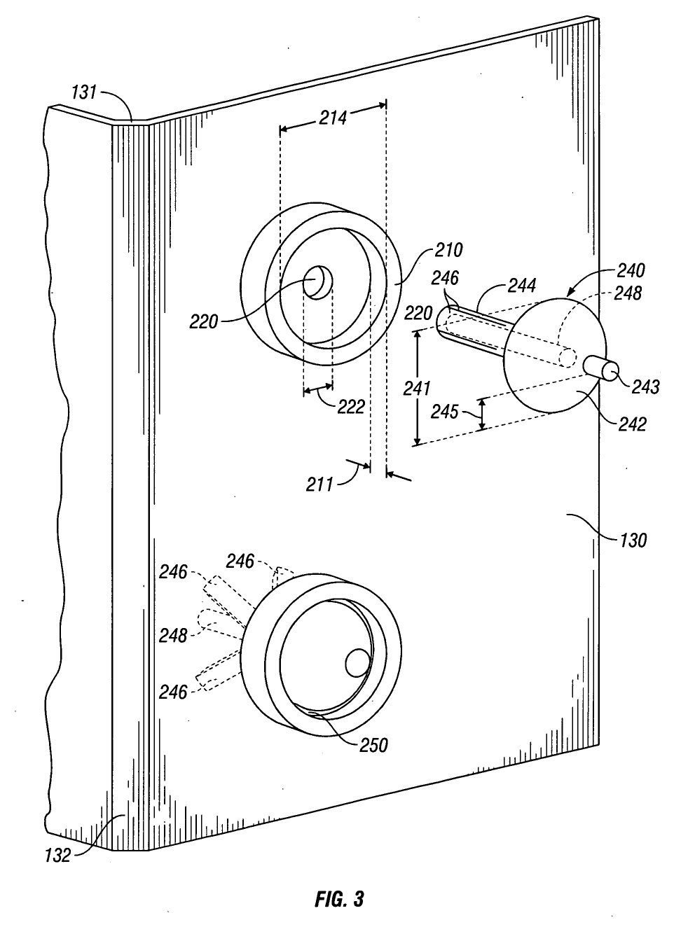

As seen in FIG. 2, attachment receiver 200 is comprised of receiver rim 210, receiver base 212, and bolt hole 220. Bolt hole 220 provides communication between vault guard 100 and pay telephone lower housing 620. Receiver base 212 is at least the same thickness as its corresponding plate, first side plate 120, second side plate 130, or face plate 110. Bolt hole 220 extends through receiver base 212. Receiver rim 210 is concentric with bolt hole 220. As shown in FIG. 3, receiver rim 210 is raised a rim distance 211 above receiver base 212. Rim distance 211 is of sufficient height such that it alters the leverage point of a pry bar (not shown), preventing a vandal from prying off attachment bolt 240.

Referring to FIGS. 2-3, receiver rim 210 has inner diameter 214 and outer diameter 216, with inner diameter 214 larger than bolt hole diameter 222. Attachment bolt 240 may be used to fasten vault guard 100 to lower housing 620. Attachment bolt 240 may be a rivet, or other similar securing means. Referring to FIG. 3, attachment bolt 240 comprises bolt head 242 and bolt shaft 244. Bolt head 242 has a bolt head diameter 241 sized to fit within inner diameter 214. Additionally, bolt head 242 has a bolt head height 245, which extends from the base (not shown) of bolt head 242, to bolt tip 243. Bolt shaft 244 is partitioned into a plurality of shaft fingers 246, which are positioned about shaft axis member 248. Shaft axis member 248 communicates with bolt tip 243, such that when force is applied to bolt tip 243, bolt tip 243 and shaft axis member 248 are projected forward, causing shaft fingers 246 to expand radially, thus mushrooming within pay telephone lower housing 620. Alternatively, any externally-applied connector, such as a moly bolt with a detactable head, may be used so long as once applied, no point of leverage exists.

Referring to FIG. 3, after attachment bolt 240 is forcibly driven through bolt hole 220, the resulting space between inner diameter 214 and bolt head 242 is bolt gap 250. Bolt gap 250 should be less than one millimeter, thereby preventing the insertion of a pry bar or similar tool between inner diameter 214 and bolt head 242. Preventing insertion of a pry bar greatly decreases the ability of removing attachment bolt 240.

Referring to FIG. 3, bolt head tip 243 can be inset, flush, or outset with respect to receiver rim 210. Rim distance 211 must be sufficient to eliminate the prying surface created by the base of bolt head 242. Therefore, in the preferred embodiment, rim distance 211 is at least one-half of bolt head height 245. Once attachment bolt 240 is properly installed, bolt head 242 should have no wrenching surfaces.

Bolt head 242 may also be of any shape, so long as bolt gap 250 is less than 1 millimeter and rim distance 211 is at least one-half of bolt head height 245. Attachment bolt 240 should be of high strength and remain externally visible to convey an appearance of structural substance in order to deter vandalism.

In practice, housing holes 660 are drilled into first side wall 640 and second side wall 650 of pay telephone lower housing 620, as seen in FIG. 1. Housing hole 660 has housing hole diameter 662 that is substantially similar in diameter to bolt hole diameter 222. Additionally, housing holes 660 are aligned with bolt holes 220. Bolt shaft 244 is sized to be received within bolt hole 220 and housing hole 660. When attachment bolt 240, bolt hole 220 and housing hole 660 are aligned, force is exerted onto bolt head 242 and bolt head tip 243, thereby thrusting bolt shaft 244 through bolt hole 220 and housing hole 660, thereby joining vault 100 and pay telephone lower housing 620. This method of installation allows vault guard 100 to be quickly and easily secured to pay telephone lower housing 620 without necessitating removal of parts. Additionally, the installation method permits installation of the vault guard 100 onto a pay telephone 600 already existing in the field.

The foregoing description of the invention illustrates a preferred embodiment thereof. Various changes may be made in the details of the illustrated construction within the scope of the appended claims without departing from the true spirit of the invention. The present invention should only be limited by the claims and their equivalents.

What is claimed is:

1. A vault guard protector for a pay telephone, said pay telephone having a vault contained in a housing, said housing having a vault access door, said vault guard comprising:
a face plate and at least two side plates,
said face plate and said at least two side plates each constructed of an impact-resistant material,
each of said at least two side plates connected to said face plate;
said face plate and said at least two side plates configured to closely fit around at least three sides of said housing containing said vault;
said face plate including an access opening;
a perimeter wall extending around a perimeter of said access opening;
said perimeter wall extending outwardly from said face plate a perimeter wall distance;
said at least two side plates each having at least one attachment receiver;
said at least one attachment receiver comprising a receiver base and a receiver rim;
said receiver base defining a bolt hole;
said bolt hole concentric with said receiver base; and
each said receiver rim extending outwardly from said side plate a rim distance.

2. A vault guard as in claim 1, wherein:
said perimeter wall distance is at least one inch.

3. A vault guard as in claim 1, said vault guard further comprising:
at least one single-use attachment bolt for each said at least attachment receiver.

4. A vault guard as in claim 3, said vault guard further comprising:
each said at least one attachment bolt having an integrally formed attachment bolt head and attachment bolt shaft;
said attachment bolt shaft axially aligned with said attachment bolt head;
said attachment bolt shaft is partitioned into a plurality of shaft fingers;
said shaft fingers surround a shaft axis;
said shaft axis projecting out a bolt head tip of said attachment bolt head; and
said shaft fingers axially expanding from said shaft axis upon forcible insertion of said attachment bolt shaft through said bolt hole.

5. A vault guard as in claim 4, wherein said at least one attachment bolt further comprises:
said bolt head having no wrenching surfaces.

6. A vault guard as in claim 4, wherein:
said attachment bolt head has an attachment bolt head height; and
said rim distance is at least one-half of said attachment bolt head height.

7. A vault guard protector for a pay telephone, said pay telephone having a vault contained in a housing, said housing having a vault access door, said vault guard comprising:
a face plate and at least two side plates,
said face plate and said at least two side plates each constructed of an impact-resistant material,
each of said at least two side plates connected to said face plate;
said face plate and said at least two side plates configured to closely fit around at least three sides of said housing containing said vault;
said face plate including an access opening;
a perimeter wall extending around a perimeter of said access opening;
said perimeter wall extending outwardly from said face plate a perimeter wall distance;
said perimeter wall distance is at least one inch;
said at least two side plates each having at least one attachment receiver;
said at least one attachment receiver comprising a receiver base and a receiver rim;
said receiver base defining a bolt hole;
said bolt hole concentric with said receiver base;
each said receiver rim extending outwardly from said side plate a rim distance; and
at least one single-use attachment bolt for each said at least attachment receiver.

8. A vault guard as in claim 7, wherein:
each said at least one attachment bolt having an integrally formed attachment bolt head and attachment bolt shaft;
said attachment bolt shaft axially aligned with said attachment bolt head;
said attachment bolt shaft is partitioned into a plurality of shaft fingers;
said shaft fingers surround a shaft axis;
said shaft axis projecting out a bolt head tip of said attachment bolt head;
said shaft fingers axially expanding from said shaft axis upon forcible insertion of said attachment bolt shaft through said bolt hole;
said attachment bolt head has an attachment bolt head height; and
said rim distance is at least one-half of said attachment bolt head height.

9. A vault guard protector for a pay telephone, said pay telephone having a vault contained in a housing, said housing having a vault access door, said vault guard comprising:
a face plate and at least two side plates,
said face plate and said at least two side plates each constructed of an impact-resistant material,
each of said at least two side plates connected to said face plate;
said face plate and said at least two side plates configured to closely fit around at least three sides of said housing containing said vault;
said face plate including an access opening;
a perimeter wall extending around a perimeter of said access opening;
said perimeter wall extending outwardly from said face plate a perimeter wall distance;
said perimeter wall distance is at least one inch;
said at least two side plates each having at least one attachment receiver;
said at least one attachment receiver comprising a receiver base and a receiver rim;
said receiver base defining a bolt hole;
said bolt hole concentric with said receiver base;
each said receiver rim extending outwardly from said side plate a rim distance;
at least one single-use attachment bolt for each said at least attachment receiver;
each said at least one attachment bolt having an integrally formed attachment bolt head and attachment bolt shaft;
said attachment bolt shaft axially aligned with said attachment bolt head;
said attachment bolt shaft is partitioned into a plurality of shaft fingers;
said shaft fingers surround a shaft axis;
said shaft axis projecting out a bolt head tip of said attachment bolt head;
said shaft fingers axially expanding from said shaft axis upon forcible insertion of said attachment bolt shaft through said bolt hole;
said attachment bolt head has an attachment bolt head height; and
said rim distance is at least one-half of said attachment bolt head height.
